(19) United States
(12) Patent Application Publication
(10) Pub. No.: US 2005/0177660 A1
(43) Pub. Date: Aug. 11, 2005

(54) Method and system for merged rate-smoothing buffer with burst buffer

(76) Inventors: Rajesh Mamidwar, San Diego, CA (US); Iue-Shuenn Chen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 10/832,750

(22) Filed: Apr. 27, 2004

Related U.S. Application Data
(60) Provisional application No. 60/542,584, filed on Feb. 5, 2004.

(51) Int. Cl. G06F 13/00

(52) U.S. Cl. 710/52

(57) ABSTRACT

In data processing applications, a method and system for a single data buffer and a data buffer controller for merging rate-smoothing and burst buffering functionalities to process incoming data streams in integrated circuits is provided. The data buffer controller may comprise a data processor and an output controller. The incoming data stream may be received by the single data buffer prior to processing or may be received by a data processor directly. The data processor processes data blocks from the incoming data, transfers the processed data blocks into the single data buffer, and notifies the output controller that the data blocks have been transferred to the single data buffer. The output controller selects data blocks to assemble a data block burst, arbitrates access to a memory bus with a bus controller, and notifies the single data buffer to transfer the data block burst when access has been granted.

### CROSS-REFERENCE TO RELATED APPLICATIONS/INCORPORATION BY REFERENCE

This application makes reference to, claims priority to, and claims the benefit of: U.S. Provisional Application Ser. No. 60/542,584 filed Feb. 5, 2004.

The above referenced application is hereby incorporated herein by reference in its entirety.

### FIELD OF THE INVENTION

Certain embodiments of the invention relate to the collection and processing of incoming data streams from serial communication channels. More specifically, the invention provides a method and system for a merged rate-smoothing buffer with burst buffer.

### BACKGROUND OF THE INVENTION

In some conventional data processing applications, it may be necessary to buffer an incoming data stream before the data stream is processed and before processed data is transferred to main memory. One such application that may require input buffering is a video data processing application, where data from multiple sources may arrive at different rates or in bursts and an input buffer may serve to smooth out rate variations. An output buffer may also be required to store processed data until access to a memory bus is granted. In most instances, a burst of processed-data may be transferred to main memory from the output buffer.

FIG. 1A is a diagram of an exemplary rate-smoothing and burst buffering system for processing incoming data streams in data processing chips. Referring to FIG. 1A, the buffering system 100 may comprise an input buffer 102, a data processor 104, an output buffer 106, and a bus controller 108. The buffering system 100 may be an exemplary System-On-Chip (SOC) buffering design used for video data processing. Because data processing in an SOC is generally designed to operate within an optimal processing rate range, data from incoming data streams that arrives at varying rates may need to be stored in an input buffer 102 to smooth out the rate variations before transferring the data out of the input buffer 102 at a rate that a data processor 104 may be capable of processing. Depending on the application, the incoming data stream may contain, for example, data packets, data cells, or data frames. Each data packet, data cell, or data frame may comprise smaller data elements or data blocks. The input buffer 102 may need to store a significantly large number of data blocks in order to handle the difference between the incoming rate and the transfer rate to the data processor 104. When the incoming rate is faster than the transfer rate, there will be a net accumulation of data blocks stored in the input buffer 102. When the incoming rate is slower than the transfer rate, there will be a net reduction of data blocks stored in the input buffer 102. If the incoming rate drops below the transfer rate for a sufficient period of time, the input buffer 102 may be depleted of stored data blocks, at which point the transfer rate may only be as fast as the incoming rate.

The processed data blocks may be stored in an output buffer 106 before being transferred to memory through a memory bus. Access to the memory bus is generally controlled by a bus controller 108. Because the bandwidth of the memory bus is limited and because many hardware resources vie for access to the memory through the memory bus, the bus controller 108 provides a systematic and efficient manner to schedule memory access by arbitration with its many hardware clients. The output buffer 106 may arbitrate with the bus controller 108 until it gains access to the memory bus and can transfer the processed data blocks to the memory. In order to provide efficient use of memory bus bandwidth by increasing the intervals between transfer requests, the bus controller 108 may require that the data blocks be transferred from the output buffer 106 in a data block burst. The number of data blocks in the data block burst may be determined by, for example, a burst length parameter. The bus controller 108 may select the burst length parameter from among a plurality of burst length parameters that it may be able to support. The output buffer 106 may then assemble the data block burst according to the burst length parameter selected and transfer the assembled data block burst once the arbitration with the bus controller provides output buffer 106 with access to the memory bus. Because data blocks in the output buffer 106 may originally be part of a data packet, data cell, or data frame, selecting and assembling data blocks for the data block burst may be based, for example, on an association that exists among the data blocks and their original data packet, data cell, and/or data frame.

FIG. 1B illustrates an exemplary buffering configuration that may be utilized by rate-smoothing and burst buffers for processing incoming data streams in data processing chips. Referring to FIG. 1B, input buffer 102 in buffering system 100 may comprise at least one buffer slot 110, where the number of buffer slots in input buffer 102 may be system dependent. Each buffer slot 110 may comprise at least one data block location 112, where each data block in a data block location 112 may contain at least one bit of information. In the illustrative example of FIG. 1B, there are (N+1) buffer slots in the input buffer 102 and (M+1) data block locations in each buffer slot 110. As data blocks from the incoming data stream arrive into the input buffer 102 they are stored in available data block locations 112 in buffer slots 110. The placement of data blocks may be determined by the input buffer 102 according to a data management criteria. The total number of memory bits in input buffer 102 for this exemplary configuration may be (M+1)×(N+1)×number of bits in a data block.

The output buffer 106 in the illustrative example in FIG. 1B may comprise at least one FIFO 114, where the number of FIFOs in the input buffer 102 may be system dependent. Each FIFO 114 may comprise at least one data block location 116 that may depend on the burst length parameter supported by bus controller 108. For example, the number of data block locations may correspond to the number of data blocks that may be transferred according to the burst length parameter. Each data block in a data block location 116 may contain at least one bit of information. In this illustrative example, there are (K+1) FIFOs in the output buffer 106 and (L+1) data block locations in each FIFO 114. As processed data blocks arrive from the data processor 104, the output buffer 106 may store the processed data blocks into a FIFO 114 until the FIFO is full. If the number of data block locations corresponds to the burst length parameter, the full FIFO may be transferred out of output buffer 106 when access to the memory bus is granted by the bus controller 108. Meanwhile, the output buffer 106 may continue to fill all other FIFOs with the processed data blocks transferred from the data processor 104. The total number of memory bits in output buffer 106 for this exemplary configuration may be (L+1)×(K+1)×number of bits in a data block. An SOC design for processing incoming data streams based on the illustrative example in FIG. 1B may need chip memory for rate-smoothing and burst buffering that may equal to [(L+1)×(K+1)+(M+1)×(N+1)]×number of bits in a data block.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for merging rate-smoothing buffer functionality with burst buffer functionality. Aspects of the method may comprise merging at least one input data buffer with at least one burst buffer to create a single data buffer, wherein the single data buffer comprises a plurality of buffer slots for processing data blocks in the data stream. The method may also comprise processing data blocks from an incoming data stream and transferring the processed data blocks into buffer slots inside the single data buffer. A portion of the data blocks transferred to the single data buffer may be selected to assemble a data block burst based on a burst length parameter. The data block burst may be transferred out of the single data buffer and to the memory bus for storage in memory. At least one incoming data stream may be selected for processing and at least one burst length parameter may be selected for data block burst transfers. A portion of the data block burst may be masked if the number of data blocks in the data block burst is less than the burst length parameter.

The instances when the incoming data stream rate may require smoothing, the data blocks of the incoming data stream may be stored in the single data buffer before processing. In this regard, the data blocks may be stored in at least one buffer slot in the single data buffer. Each buffer slot may have at least one buffer slot location where the data blocks may be stored. The data blocks may be transferred out of the single data buffer for processing. In instances when multiple incoming data streams may be available for processing, selecting one incoming data stream for storage of its data blocks may be necessary. When the incoming data stream rate may not need smoothing, the data blocks of the incoming data stream may be processed directly without prior storage in the single data buffer. When multiple incoming data streams may be available for processing, one incoming data stream may be selected for direct processing of its data blocks.

When processing the data blocks of the incoming data stream, at least a portion of the data blocks may be processed by using a data table. The data table used for processing may be one of several data tables which may be available for processing the data blocks. A notification may be generated to indicate completion of the processing of at least one data block. This completion notification may be used to update at least one counter used to track the selection and assembling of the data burst block. A notification may be generated to indicate transfer of the processed data blocks to the single data buffer. This transfer notification may be used to update at least one stack pointer used to track the selection and/or assembling of the data burst block. A data block burst transfer from the single data buffer may be arbitrated with a bus controller and a notification may be sent to the single data buffer to transfer the data block burst out to the bus controller.

Another aspect of the invention described herein provides a system for processing data streams that merges rate-smoothing and burst buffering functionalities into the single data buffer. The system may comprise the single data buffer, a data buffer controller, and a processor. The data buffer controller may comprise a data processor and an output controller. The processor may be used to control the data buffer controller. The data processor may process the data blocks from an incoming data stream and may transfer the processed data blocks into buffer slots inside the single data buffer. The output controller may select a portion of the data blocks transferred by the data processor to the single data buffer to assemble a data block burst based on a burst length parameter. The single data buffer may transfer, upon notification from the output controller, the data block burst out of the single data buffer. The data buffer controller may select at least one incoming data stream to be processed. The output controller may select one of a plurality of burst length parameters to be used for data block burst transfers. The output controller may mask a portion of the data block burst if the number of data blocks in the data block burst is less than the burst length parameter.

In instances when the incoming data stream rate may require smoothing, the data blocks of the incoming data stream may be stored in the single data buffer before being processed by the data processor. The data blocks may be stored in at least one buffer slot in the single data buffer and each buffer slot may have at least one buffer slot location where the data blocks may be stored. The data blocks may be transferred out of the single data buffer for processing by the data processor. When multiple incoming data streams may be available for processing, the data buffer controller may be used to select one incoming data stream for storage and then processing. In instances when the incoming data stream rate may not need smoothing, the data blocks of the incoming data stream may be processed directly by the data processor without prior storage in the single data buffer. When multiple incoming data streams may be available for processing, the data buffer controller may be used to select one incoming data stream for direct processing of its data blocks.

The data processor may process at least a portion of the data block by using a data table. The data table used for processing may be one of a plurality of data tables which may be available for processing the data blocks. The data processor may generate a notification to the output controller to indicate completion of the processing of at least one data block. This completion notification may be used by the output controller to update at least one counter used to track the selection and assembling of the data burst block. The data processor may generate a notification to the output controller to indicate transfer of the processed data blocks to the single data buffer. This transfer notification may be used by the output controller to update at least one stack pointer used to track the selection and/or assembling of the data burst block. The output controller may arbitrate with a bus controller the transfer of the data block burst transfer from the single data buffer and may notify the single data buffer to transfer the data block burst out to the bus controller.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram of an exemplary rate-smoothing and burst buffering system for processing incoming data streams in data processing chips.

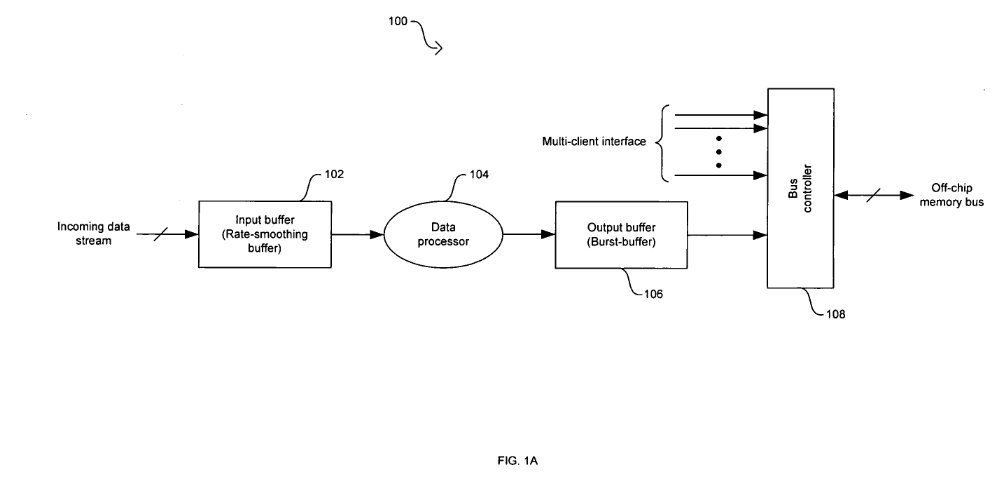

FIG. 1B illustrates an exemplary buffering configuration that may be utilized by rate-smoothing and burst buffers for processing incoming data streams in data processing chips.

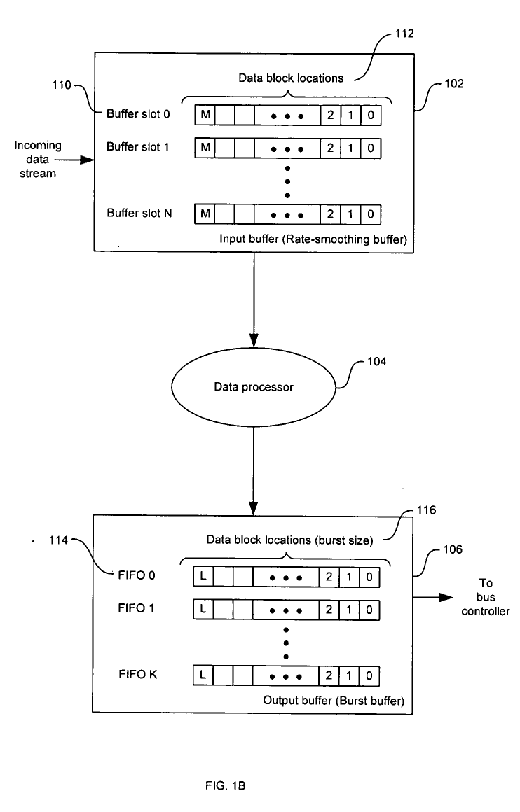

FIG. 2A is a diagram of an exemplary single data buffer system with merged rate-smoothing and burst buffering for processing incoming data streams in data processing chips or ICs, in accordance with an embodiment of this invention.

FIGS. 2B-2D illustrate exemplary processing configurations that may be utilized by a single data buffer system, in accordance with an embodiment of this invention.

FIG. 2E illustrates an exemplary buffering configuration that may be utilized by a single data buffer, in accordance with an embodiment of this invention.

FIG. 3 contains a flow chart showing a process that may be utilized by a single data buffer system for rate-smoothing, processing, and burst buffering data blocks from an incoming data stream, in accordance with an embodiment of this invention.

FIG. 4 is a diagram of an exemplary configuration that may be utilized for selecting an incoming data stream for processing by a single data buffer system, in accordance with an embodiment of this invention.

### DETAILED DESCRIPTION OF THE INVENTION

Certain embodiments of the invention may be found in a method and system for merged rate-smoothing buffer with burst buffer. System-on-Chip (SOC) designs for data processing applications have ever increasing demands on size and speed requirements in order to reduce cost and improve performance. SOCs first buffer incoming data streams to smooth out rate variations in data coming from multiple sources and to smooth out bursty data. After processing the data in the incoming data stream, SOCs again buffer the data for efficient memory bus utilization during burst data transfers to main memory. Merging the rate-smoothing and bursting functionalities into a single data buffer may produce smaller chip area, increase processing speed, and reduce manufacturing costs.

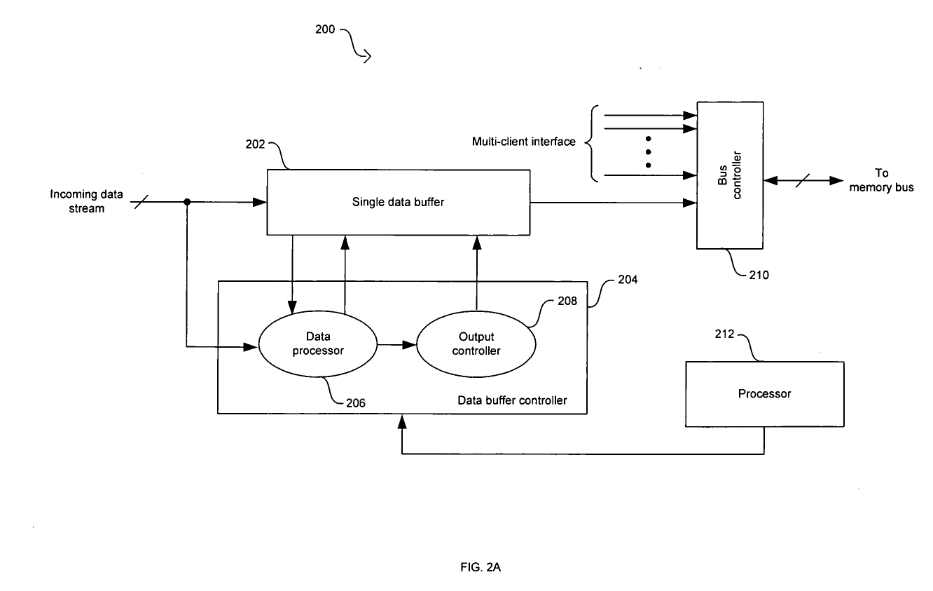

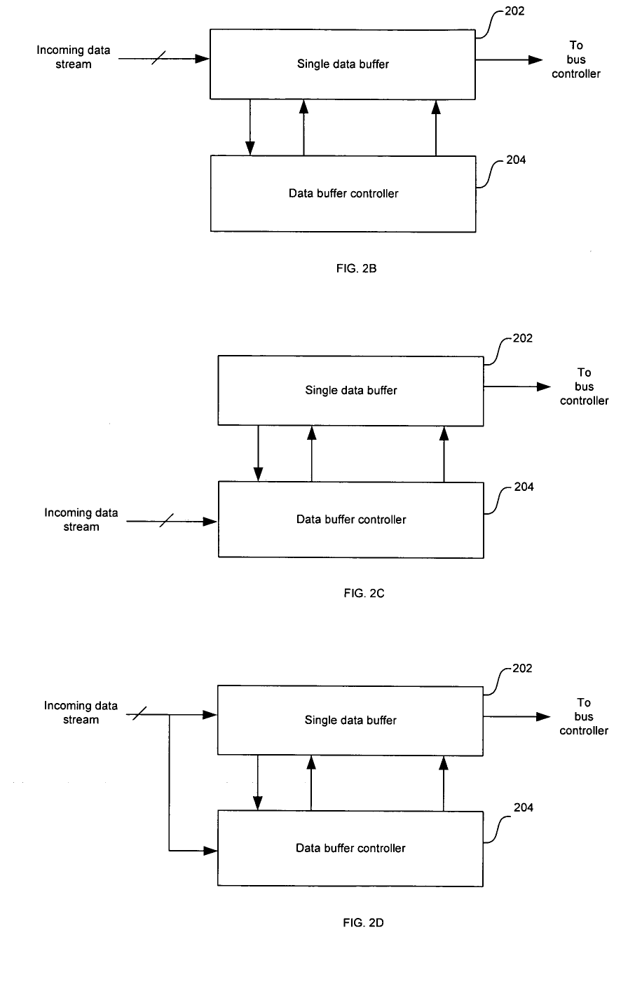

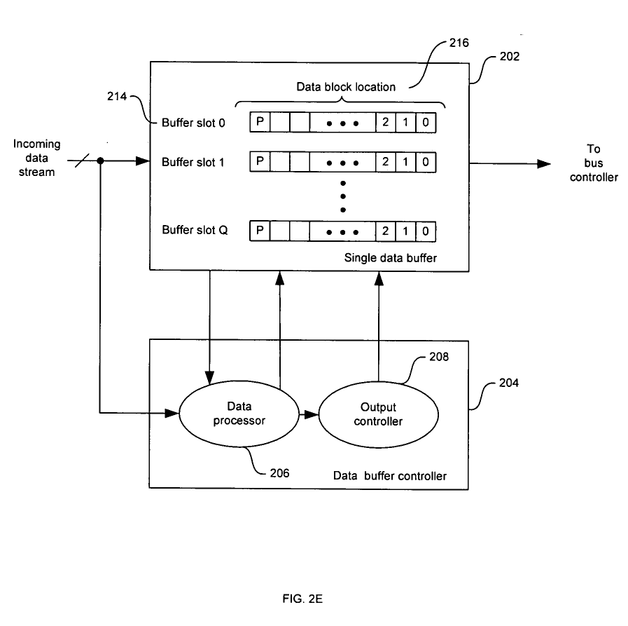

FIG. 2A is a diagram of an exemplary single data buffer system with merged rate-smoothing and burst buffering for processing incoming data streams in data processing chips or ICs, in accordance with an embodiment of this invention. The single data buffer system 200 may comprise a single data buffer 202, a data buffer controller 204, a processor 212, and a bus controller 210. The data buffer controller 204 may comprise a data processor 206 and an output controller 208.

The single data buffer 202 may be a RAM memory resource which may be synchronous or asynchronous, static or dynamic, single data rate or double data rate. The data buffer controller 204 may be a dedicated hardware resource or it may be a processor, coprocessor, microcontroller, or a digital signal processor and may contain memory. The data processor 206 may be a dedicated hardware resource for processing data blocks or it may be a processor, coprocessor, microcontroller, or a digital signal processor and may contain memory. The output controller 208 may be a dedicated hardware resource for controlling the output of the single data buffer 202, or it may be a processor, coprocessor, microcontroller, or a digital signal processor and may contain memory. The processor 212 may be dedicated hardware resource which may be utilized for controlling the data buffer controller 204, or it may be a processor, coprocessor, microcontroller, or a digital signal processor and may contain memory. The bus controller 210 may be a dedicated hardware resource which may be utilized for controlling access to a memory bus.

The single data buffer 202 may store data blocks from an incoming data stream and may transfer the stored data blocks to the data processor 206 for processing. Storage of the incoming data blocks may be carried out in accordance to an incoming data management criteria. Processed data blocks transferred from the data processor 206 may be stored in the single data buffer 202. Storage of the processed data blocks may be carried out in accordance with processed data management criteria. The single data buffer 202 may store processed data blocks until notified to transfer to the memory bus, a data block burst comprising selected and assembled processed data blocks.

The data buffer controller 204 may receive for processing data blocks from an incoming data stream. Data blocks from the single data buffer 202 may be transferred to the data buffer controller 204 for processing. The data buffer controller 204 may accept or reject data blocks, may modify the order of data blocks in a sequence, modify the contents of a data block, and/or generate pointers to process data blocks by other hardware resources in the system. At least one data block may be processed by the data buffer controller 204 at a time. The data buffer controller 204 may transfer processed data blocks to the single data buffer 202. Access to the memory bus may be gained by the data buffer controller 204 by arbitrating with the bus controller 210. The data buffer controller 204 may select and/or assemble the processed data blocks that may comprise the data block burst. The data buffer controller 204 may mask a portion of the data block burst based on the burst length parameter and may generate notifications to the single data buffer 202 for transferring the data block burst to the memory bus once access has been gained. The data buffer controller 204 may transfer data and/or control information with the processor 212. The data buffer controller 204 may determine if incoming data streams may be stored in the single data buffer 202 before processing or if the incoming data streams may be processed directly.

The data processor 206 may receive data blocks from an incoming data stream for processing. Data blocks from the single data buffer 202 may be transferred to the data processor 206 for processing. The data processor 206 may accept or reject data blocks, modify the order of data blocks in a sequence, modify the contents of a data block, and/or generate pointers to process data blocks by other hardware resources in the system. The data processor 206 may process at least one data block at a time, and may transfer the processed data blocks to the single data buffer 202. The data processor 206 may notify the output controller 208 when processing of data blocks has been completed and may also provide the location of the processed data blocks in the single data buffer 202. Data and/or control information may be transferred by the data processor 206 to the processor 212. The data processor 206 may determine if incoming data streams may be stored in the single data buffer 202 before processing or if the incoming data streams may be processed directly.

The output controller 208 may arbitrate with the bus controller 210 to gain access to the memory bus and may select and/or assemble the processed data blocks that may comprise the data block burst to be transferred through the memory bus. The output controller 208 may mask a portion of the data block burst based on the burst length parameter and may generate notifications to the single data buffer 202 for transferring the data block burst to the memory bus once access has been gained. Data and/or control information may be transferred by the output controller 208 to the processor 212.

FIGS. 2B-2D illustrate exemplary processing configurations that may be utilized by a single data buffer system, in accordance with an embodiment of this invention. Referring to FIG. 2B, the data blocks of an incoming data stream may be stored in the single data buffer 202 before processing by the data buffer controller 204. In this exemplary configuration, incoming data blocks are transferred to the data buffer controller 204 and processed data blocks may be transferred to the single data buffer 202. Referring to FIG. 2C, in a different exemplary configuration, the data blocks of an incoming data stream may be processed directly by the data buffer controller 204 and processed data blocks are transferred to the single data buffer 202. Referring to FIG. 2D, in a different exemplary configuration, the data blocks of an incoming data stream may be stored in the single data buffer 202 before processing by the data buffer controller 204 or may be processed by the data buffer controller 204 directly. The data buffer controller 204 determines whether the incoming data stream may be stored first or may be processed directly. This determination may be carried out according to an established criteria. An example of such criteria may be that when the incoming data stream rate is faster than the processing rate range of the data buffer controller 204, data blocks may be stored in single data buffer 202 for it to smooth out the incoming rate. When the incoming data stream rate is within the processing rate range of the data buffer controller 204, data blocks may be processed directly by the data buffer controller 204. Moreover, when the incoming data stream is slower than the processing rate range of the data buffer controller 204, data blocks may be stored in single data buffer 202 for it to smooth out the incoming rate. In the exemplary configurations referred to in FIGS. 2B-2D, the processed data blocks are transferred from the data buffer controller 204 to the single data buffer 202.

FIG. 2E illustrates an exemplary buffering configuration that may be utilized by a single data buffer, in accordance with an embodiment of this invention. Referring to FIG. 2E, the single data buffer 202 may comprise at least one buffer slot 214, where the number of buffer slots in the single data buffer 202 may be system dependent. Each buffer slot 214 may comprise at least one data block location 216, where each data block stored in a data block location 216 may contain at least one bit of information. In this illustrative example, there are (Q+1) buffer slots in the single data buffer 202 and (P+1) data block locations in each buffer slot 214. The buffer slots in the single data buffer 202 may, for example, contain different number of data block locations depending on the system. As data blocks from the incoming data stream arrive into the single data buffer 202, they may be stored in available data block locations 216 in buffer slots 214. The placement of incoming data blocks may be determined by the single data buffer 202 according to an incoming data management criteria. Similarly, processed data blocks transferred from the data buffer controller 204 to the single data buffer 202 may be stored in available data block locations in the buffer slots. The placement of processed data blocks may be determined by the single data buffer 202 according to a processed data management criteria. Processed data blocks may be selected from any data block location 216 in the buffer slots to assemble the data block burst. The selection of processed data blocks to assemble the data block burst may be determined by the single data buffer 202 and/or the data buffer controller 204 according to a data burst management criteria. The total number of memory bits that may be required in the single data buffer 202 for rate-smoothing and burst buffering in this exemplary configuration may be (P+1)×(Q+1)×number of bits in a data block.

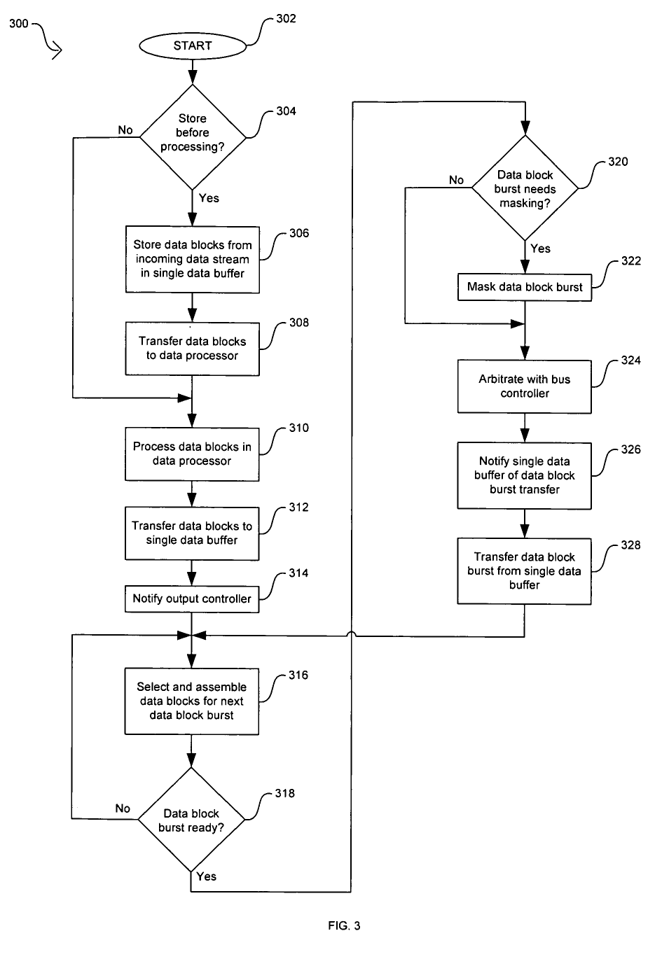

FIG. 3 contains a flow chart showing a process that may be utilized by a single data buffer system for rate-smoothing, processing, and burst buffering data blocks from an incoming data stream, in accordance with an embodiment of this invention. Referring to FIG. 3, after start step 302, the single data buffer system 200, for example, may determine in step 304 whether the data blocks of the incoming data stream may need to be stored in the single data buffer 202. If the data blocks need to be stored in the single data buffer 202, then in step 306 the data blocks may be stored in the available data block locations 216 in buffer slots 214 according to the incoming data management criteria. In step 308, the single data buffer 202 may transfer the stored data blocks to the data processor 206 in the data buffer controller 204. At least one data block may be transferred from the single data buffer 202 to the data processor 206. In step 310, the data processor 206 processes the data blocks transferred from the single data buffer 202. Referring back to step 304, if the data blocks may not need to be stored in the single data buffer 202, then the data blocks may be processed directly by the data processor 206 in step 310.

Once processing of at least one data block may have been completed, the processed data blocks may be transferred to the single data buffer 202 from the data processor 206 in step 312. In step 314, the data processor 206 may notify the output controller 208 that at least one data block has been processed and may also provide information that indicates the data block location 216 and the buffer slot 214 where the processed data blocks may be stored. In step 316 the output controller 208 may begin to select the processed data blocks in the single data buffer 202 that may be assembled to comprise the data block burst. In step 318, the output controller 208 may determine from the number of data blocks assembled and from their association to an original data packet, data cell, or data frame, whether the data block burst may be ready to be transferred out of the single data buffer 202. If the data block burst is not ready for transfer, the output controller 208 returns to step 316. In instances where the data block burst may be ready for transfer, the output controller 208 may determine in step 320 whether the data block burst length may require masking. If the data block burst is the same length as the burst length parameter, the data block burst may not need masking and the output controller 208 may proceed to step 324. If the data block burst has fewer data blocks than required by the burst length parameter, the output controller 208 may mask or pad the data block burst in step 322 to meet the burst length parameter.

In instances where the data block burst may be ready for transfer, and masking may not need to be performed, the output controller 208 may arbitrate in step 324 with the bus controller to gain access to the bus memory for transferring the data block burst to the main memory. In step 326, once arbitration may have produced access to the memory bus, the output controller 208 may notify the single data buffer 202 that the assembled data block burst may be transferred to the memory bus. In step 328, the single data buffer 202 may transfer the data block burst to the memory bus. Once the transfer occurs, the output controller 208 returns to step 316 where it may begin to select and assemble the next data block burst for transferring to the memory bus.

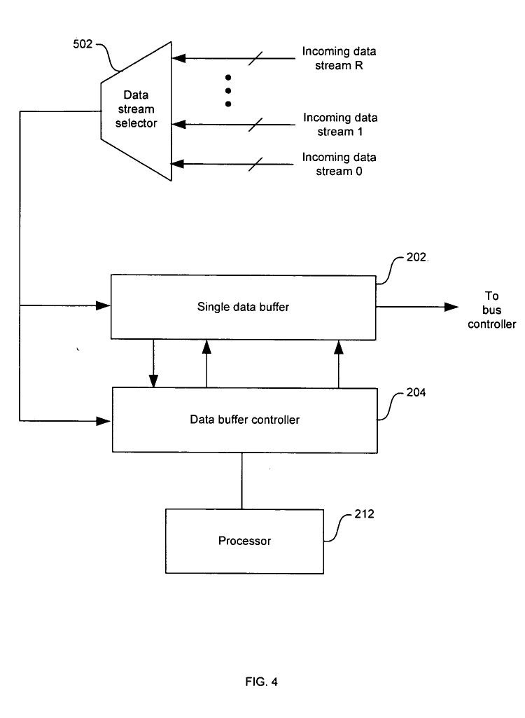

FIG. 4 is a diagram of an exemplary configuration that may be utilized for selecting an incoming data stream for processing by a single data buffer system, in accordance with an embodiment of this invention. Referring to FIG. 4A, there is shown the single data buffer 202, the data buffer controller 204, the processor 212, a data stream selector 502, and (R+1) incoming data streams. The data stream selector 502 may be used to select from the (R+1) incoming data streams to be processed by the data buffer controller 204, buffered by the single data buffer 202, and then stored in memory. The data stream selector 502 may be instructed by the data buffer controller 204 or by the processor 212 as to which of the (R+1) incoming data streams to select.

By merging the rate-smoothing and bursting functionalities into a single data buffer, it may be possible to produce smaller chip area, increase processing speed, and reduce manufacturing costs.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for processing data streams, the method comprising:
processing at least one of a plurality of data blocks;
transferring said processed at least one of a plurality of data blocks into at least one of a plurality of buffer slots in a single data buffer comprising merged data buffers and burst buffers;
selecting at least one of said transferred processed at least one of a plurality of data blocks from said at least one of a plurality of buffer slots in said single data buffer; and
transferring a data block burst from at least a portion of said selected transferred processed at least one of a plurality of data blocks.

2. The method in claim 1, further comprising assembling said at least a portion of said selected transferred processed at least one of a plurality of data blocks into said transferred data block burst based on at least one of a plurality of burst length parameters.

3. The method according to claim 2, further comprising selecting at least one of said at least one of a plurality of burst length parameters.

4. The method according to claim 3, further comprising masking at least a portion of said transferred data block burst if said data block burst length is less than required by said selected at least one of a plurality of burst length parameters.

5. The method according to claim 1, further comprising selecting between storing in said single data buffer before said processing said at least one of a plurality of data blocks received by said single data buffer from at least one of a plurality of incoming data streams and performing said processing directly on said at least one of a plurality of data blocks from said at least one of a plurality of incoming data streams.

6. The method according to claim 5, further comprising storing said at least one of a plurality of data blocks into said at least one of a plurality of buffer slots in said single data buffer if said storing before said processing was selected.

7. The method according to claim 5, further comprising transferring for said processing said at least one of a plurality of data blocks from said at least one of a plurality of buffer slots in said single data buffer if said storing before said processing was selected.

8. The method according to claim 5, further comprising selecting said at least one of a plurality of incoming data streams if said storing before said processing was selected.

9. The method according to claim 5, further comprising selecting said at least one of a plurality of incoming data streams if said direct processing was selected.

10. The method according to claim 1, further comprising processing at least a portion of said at least one of a plurality of data blocks by using at least one of a plurality of data tables.

11. The method according to claim 1, further comprising generating a notification indicating completion of said processing of said at least one of a plurality of data blocks.

12. The method according to claim 11, further comprising updating at least one of a plurality of counters based on said notification to track said transfer of said data block burst.

13. The method according to claim 1, further comprising generating a notification indicating a buffer slot location in said at least one of a plurality of buffer slots where said processed at least one of a plurality of data blocks has been transferred.

14. The method according to claim 13, further comprising updating at least one of a plurality of stack pointers based on said notification to track said transfer of said data block burst.

15. The method according to claim 1, further comprising arbitrating said transfer of said data block burst with a bus controller.

16. The method according to claim 1, further comprising notifying said single data buffer to transfer said data block burst.

17. A method for processing data streams, the method comprising merging at least one input data buffer with at least one burst buffer to create a single data buffer, wherein said single data buffer comprises a plurality of buffer slots for processing data blocks in the data stream.

18. The method according to claim 17, further comprising transferring a data block burst from said single data buffer.

19. The method according to claim 17, further comprising processing a plurality of data blocks and storing said processed plurality of data blocks in said single data buffer.

20. A system for processing data streams, the system comprising:
a data buffer controller comprising a data processor and an output controller;
a data processor that processes at least one of a plurality of data blocks;
said data processor transfers said processed at least one of a plurality of data blocks into at least one of a plurality of buffer slots in a single data buffer comprising merged data buffers and burst buffers;
said output controller selects at least one of said transferred processed at least one of a plurality of data blocks from said at least one of a plurality of buffer slots in said single data buffer; and
said single data buffer transfers a data block burst from at least a portion of said selected transferred processed at least one of a plurality of data blocks.

21. The system in claim 20, wherein said output controller assembles said at least a portion of said selected transferred processed at least one of a plurality of data blocks into said transferred data block burst based on at least one of a plurality of burst length parameters.

22. The system according to claim 21, wherein said output controller selects at least one of said at least one of a plurality of burst length parameters.

23. The system according to claim 12, wherein said output controller masks at least a portion of said transferred data block burst if said data block burst length is less than required by said selected at least one of a plurality of burst length parameters.

24. The system according to claim 20, wherein said data buffer controller selects between storing in said single data buffer before said processing said at least one of a plurality of data blocks received by said single data buffer from at least one of a plurality of incoming data streams and performing said processing directly on said at least one of a plurality of data blocks from said at least one of a plurality of incoming data streams.

25. The system according to claim 24, wherein said single data buffer stores said at least one of a plurality of data blocks into said at least one of a plurality of buffer slots in said single data buffer if said storing before said processing was selected.

26. The system according to claim 24, wherein said single data buffer transfers to said data processor for said processing said at least one of a plurality of data blocks from said at least one of a plurality of buffer slots in said single data buffer if said storing before said processing was selected.

27. The system according to claim 24, wherein said data buffer controller selects said at least one of a plurality of incoming data streams if said direct processing was selected.

28. The system according to claim 20, wherein said data processor processes at least a portion of said at least one of a plurality of data blocks by using at least one of a plurality of data tables.

29. The system according to claim 28, wherein said data table is updated by a processor.

30. The system according to claim 20, wherein said data processor generates a notification to said output controller indicating completion of said processing of said at least one of a plurality of data blocks.

31. The system according to claim 30, wherein said output controller updates at least one of a plurality of counters based on said notification from said data processor to track said transfer of said data block burst.

32. The system according to claim 30, wherein said data processor generates a notification to said output controller indicating a buffer slot location in said at least one of a plurality of buffer slots where said processed at least one of a plurality of data blocks has been transferred.

33. The system according to claim 32, wherein said output controller updates at least one of a plurality of stack pointers based on said notification from said data processor to track said transfer of said data block burst.

34. The system according to claim 20, wherein said output controller arbitrates said transfer of said data block burst with a bus controller.

35. The system according to claim 20, wherein said data buffer controller is controlled by a processor.

36. The system according to claim 20, wherein said data buffer controller notifies said single data buffer to transfer said data block burst.

37. A system for processing data streams, the system comprising a single data buffer that merges at least one input data buffer with at least one burst buffer, wherein said single data buffer comprises a plurality of buffer slots for processing data blocks in the data stream.

38. The system according to claim 37, wherein said single data buffer transfers a data block burst.

39. The system according to claim 37, wherein said single data buffer stores a plurality of processed data blocks.
